(19) United States
(12) Patent Application Publication
(10) Pub. No.: US 2019/0201725 A1
(43) Pub. Date: Jul. 4, 2019

(54) MOLD TRANSFORMER WITH SOLID AEROSOL FIRE EXTINGUISHER

(71) Applicant: KEY ENGINEERING CO., LTD., Busan (KR)

(72) Inventor: Jin-Han BAE, Busan (KR)

(21) Appl. No.: 16/051,720

(22) Filed: Aug. 1, 2018

(30) Foreign Application Priority Data
Jan. 4, 2018 (KR) 10-2018-0001274

(51) Int. Cl. A62C 3/16; A62C 35/02; A62C 35/68; A62C 35/62

(52) U.S. Cl. CPC A62C 3/16; A62C 35/62; A62C 35/68; A62C 35/023

(57) ABSTRACT

The present invention relates to a mold transformer with a solid aerosol fire extinguisher, and more particularly, to a mold transformer which is further provided with a fire extinguisher to spray a fire extinguishing agent to coils to rapidly suppress and extinguish a fire when the fire breaks out in the mold transformer or its surroundings, by preventing the fire breaking out in the mold transformer from spreading to the outside and preventing the fire breaking out outside from spreading to the mold transformer, thereby enabling early suppression and prevention of a fire. The fire extinguisher sprays a solid aerosol as the fire extinguishing agent to a space between the coils or to the outer wall of a primary coil.

### CROSS REFERENCE TO RELATED APPLICATIONS

This application is related to and claims priority from Korea Patent Application No. KR 10-2018-0001274 filed Jan. 4, 2018, which is incorporated herein by reference in its entirety.

### TECHNICAL FIELD

The present invention relates to a mold transformer with a solid aerosol fire extinguisher, and more particularly, to a mold transformer with a fire extinguisher to rapidly extinguish a fire when the fire breaks out in the mold transformer or its surroundings, by preventing the fire breaking out in the mold transformer from spreading to the outside and preventing the fire breaking out outside from spreading to the mold transformer, thereby enabling early suppression and prevention of the fire.

### BACKGROUND ART

Generally, a mold transformer is made with a primary winding, a secondary winding and an insulating tube, which are made by using an epoxy resin as a flame resistant material for insulation. A mold transformer usually means a transformer having one or more windings which are perfectly protected by a solid insulation material. According to IEC 60076-11 of the International Electrotechnical Commission (IEC), a mold transformer is defined as a transformer having a winding which is not immersed in a liquid insulation material.

A mold transformer has a structure with a primary winding and a secondary winding basically made of an epoxy resin which is a flame resistant material, and which does not short circuit. However, if voltage is not cut off, a continuous local overcurrent is caused and therefore the windings are badly damaged by overvoltage caused by a short circuit of a wire, causing a fire.

Further, since a mineral (silica filter or glass) is small in quantity inside the windings of a mold transformer, a fire may break out. Further, since a ground wire installed outside the mold transformer is closely installed to the mold transformer and therefore an electric discharge between the surfaces of the windings and the ground wire continues, a mold transformer has the possibility of an outbreak of a fire by a spark.

That is, a mold transformer may cause a fire by itself. When a mold transformer is installed inside an enclosure or substation, since it is impossible to recognize a fire, when a fire breaks out, the fire may spread to the surroundings or the fire breaking out in the surroundings may spread to the mold transformer.

Further, since high voltage is present in a mold transformer, if a fire breaks out during the operation of the mold transformer, it is very difficult to suppress the fire. Specifically, workers to suppress the fire may be in danger due to the high voltage. When a fire breaks out inside a substation, workers cannot easily suppress the fire.

In general, a fire is defined as a reactive phenomenon which a combustible material and oxygen emit heat and light and rapidly react each other. A combustible material (a medium, fuel), oxygen (O₂) and heat, which are called the three elements of fire, are required for the outbreak of a fire. A fire breaks out when a combustible material, oxygen and an ignition source (heat, naked flame, spark, etc.) are present at the same time and place. When a fire breaks out, since the heat emitted by the fire satisfies the three elements of fire, the fire lasts as long as the combustible material and oxygen are present. Thus, to prevent the outbreak of a fire or to suppress the fire which breaks out, the removal of one of the three elements of fire or blocking a chain reaction of the three elements of fire is needed.

A prior art document, Korean Registered Patent No. 10-1559965, discloses one of the methods to suppress a fire by directly spraying a fluid (HFC-125) around coils on a mold transformer. However, in the case where a fluid is actually used in the conventional extinguisher, since a halogenated compound product is used, the ozone depletion potential (ODP) is zero (0) but the global warming potential (GWP) is 6,350. Further, since a no-observed-adverse-effect level (NOAEL) and a lowest-observed-adverse-effect level (LOAEL) in physiologically based pharmacokinetic (PBPK) modeling are high, the fluid can be used to a hermetically sealed zone only. Further, the fluid includes a harmful substance. Although hydro-fluorocarbon (HFC) is developed as an alternate material for chlorofluorocarbon (CFC) which is known as a refrigerant contributing to ozone depletion, when even a small amount of HFC is exposed in the atmosphere, since HFC's greenhouse effect is stronger a thousand times than carbon dioxide, it causes influence on global warming. In this regard, the parties to the Montreal Protocol agreed to phase down HFCs from 2019 in their 28^{th} meeting which was held in Kigali, Rwanda.

The fluid used in the conventional extinguisher or the other fluids are expensive. To suppress a fire by using the fluid, a container to keep the fluid and the relevant high pressure lines are required. Since the fluid is filled at high pressure and it is harmful to the human body, workers' care is required upon maintenance and fire suppression. As a subsidiary matter, the container also needs a regular inspection periodically.

### PRIOR ART DOCUMENT

### Patent Document

(Patent Document 0001) Korean Registered Patent No. 10-1559965

### DISCLOSURE

### Technical Problem

Therefore, it is an object of the present invention to solve the above problems and to provide a mold transformer with a solid aerosol fire extinguisher, to suppress a fire by spraying a solid aerosol gas to the fire location without leaving any residue and to prevent a reignition of fire outbreak during a certain time after extinguishing the fire.

It is another object of the present invention to provide a mold transformer with a solid aerosol fire extinguisher, to easily reduce installation expenses or maintenance fees by replacing a solid aerosol storage unit only.

It is another object of the present invention to provide a mold transformer with a solid aerosol fire extinguisher, to easily suppress a fire by intensively spraying the solid aerosol gas to a place where the most fires break out in each winding of the mold transformer.

It is another object of the present invention to provide a mold transformer with a solid aerosol fire extinguisher, to suppress a fire by installing fire extinguishing equipment in the mold transformer itself.

It is another object of the present invention to provide a mold transformer with a solid aerosol fire extinguisher, to use a fire extinguishing agent in the form of a solid aerosol which does not affect the human body and does not influence on the outside environments, without using the conventional fluid.

### Technical Solution

The present invention provides a mold transformer with a solid aerosol fire extinguisher, which comprises: a base, a lower frame positioned on the base, an upper frame held to the lower frame, a core vertically connecting the lower frame and the upper frame, a secondary coil covered with an insulation material and positioned around the core, a primary coil covered with the insulation material and positioned around the secondary coil, and a fire extinguisher positioned at one side of the upper frame, to spray a fire extinguishing agent which is a solid aerosol to a space between the primary and secondary coils and to the outer wall of the primary coil to suppress a fire.

Preferably, a support fixture is positioned at the one side of the upper frame, to support the fire extinguisher to be secured.

Further, the fire extinguisher comprises: a precipitator positioned at an end of the upper frame lengthwise, a distributing pipe extending from the precipitator and including an upper pipe and a lower pipe, and a plurality of discharge nozzles installed at the upper pipe and the lower pipe.

Further, the precipitator has its outer perimeter tapered downwardly.

Further, the discharge nozzle includes an end with a groove formed in a shape corresponding to the space between the primary and secondary coils, such that the solid aerosol is sprayed to the space through the groove.

Further, the groove is formed in a circular arc-shaped long channel corresponding to the space in a ring shape.

Further, the discharge nozzle is positioned to be close to the outer circumference surface of the secondary coil or the inner circumference surface of the primary coil.

More preferably, the discharge nozzle is terminated at its end by a bevel and flared out by the bevel to spray the solid aerosol over a greater area.

### Advantageous Effects

As described above, in the mold transformer with a solid aerosol fire extinguisher according to the present invention, the fire extinguishing agent sprayed through the discharge nozzles is directly sprayed to the space between the primary coil and the secondary coil where the risk of fire is highest, to perform a fire extinguishing function. In other words, the fire extinguishing agent sprayed through the discharge nozzles is directly sprayed to the spot of fire, thereby more rapidly suppressing the fire.

Since the discharge nozzle includes a groove formed in the shape corresponding to the space between the primary and secondary coils, the form of spraying the fire extinguishing agent also corresponds to the space between the coils and therefore the fire extinguishing agent is effectively sprayed and focused on the space.

Since the bevel formed at the end of the discharge nozzle guides the fire extinguishing agent to be sprayed over a greater area, the fire extinguishing agent is sprayed to the outside of the primary coil and the inside of the secondary coil, that is, towards the core unit, without changing the direction of the nozzle entrance of the discharge nozzle. Accordingly, the fire extinguishing agent is sprayed to the space between the coils and the outer wall or inner wall of each coil. This minimizes the number of the discharge nozzles by enabling to spray the fire extinguishing agent to all of the space between the coils, the outer wall of the primary coil and the inner wall of the secondary coil by using one nozzle only, without installing the discharge nozzles at different angles towards the space between the coils, the outer wall of the primary coil or the inner wall of the secondary coil.

Further, in the mold transformer according to the present invention, all components of the fire extinguisher are positioned in the interior space of the electric box. This is to prevent the components from being damaged or worn out by the outside environments and therefore the fire extinguisher is prevented from being damaged and is kept in a normal state for a long time.

### DESCRIPTION OF DRAWINGS

The above and other features and advantages of the present invention will become more apparent by describing in detail exemplary embodiments thereof with reference to the attached drawing(s) in which:

FIG. 1 is a schematic view of a mold transformer with a solid aerosol fire extinguisher according to the present invention;

FIG. 2 is a view illustrating a part of the mold transformer with the solid aerosol fire extinguisher;

FIG. 3 is a side view of the mold transformer with the solid aerosol fire extinguisher;

FIG. 4 is a plan view of the mold transformer with the solid aerosol fire extinguisher;

FIG. 5 is an enlarged perspective view of major parts of the mold transformer with the solid aerosol fire extinguisher;

FIG. 6A shows a perspective view of discharge nozzle of the mold transformer with the solid aerosol fire extinguisher according to one embodiment;

FIG. 6B shows a plane view of discharge nozzle of the mold transformer with the solid aerosol fire extinguisher according to one embodiment;

FIG. 6C shows a front view of discharge nozzle of the mold transformer with the solid aerosol fire extinguisher according to one embodiment; and

FIG. 7A shows a perspective view of discharge nozzle of the mold transformer with the solid aerosol fire extinguisher according to one embodiment;

FIG. 7B shows a plane view of discharge nozzle of the mold transformer with the solid aerosol fire extinguisher according to one embodiment;

FIG. 7C shows a front view of discharge nozzle of the mold transformer with the solid aerosol fire extinguisher according to one embodiment.

### MODE FOR INVENTION

The present invention will now be described more fully hereinafter with reference to the accompanying drawing(s), in which preferred embodiments of the invention are shown. This invention may, however, be embodied in many alternate forms and should not be construed as limited to only the embodiments of the present invention set forth herein.

The embodiments of the present invention will now be described more fully hereinafter with reference to the accompanying drawings. These embodiments are provided so that this disclosure will be complete, and will fully convey the scope of the invention to those skilled in the art. The present invention will be just defined by the scope of the claims. Therefore, in the embodiments, the well-known constituents, operations and skills will not be specifically described to prevent the present invention from being ambiguously interpreted.

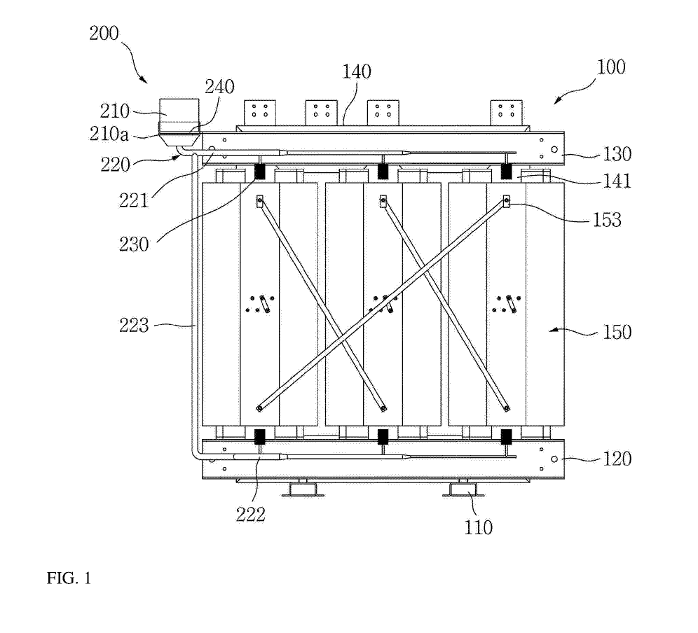

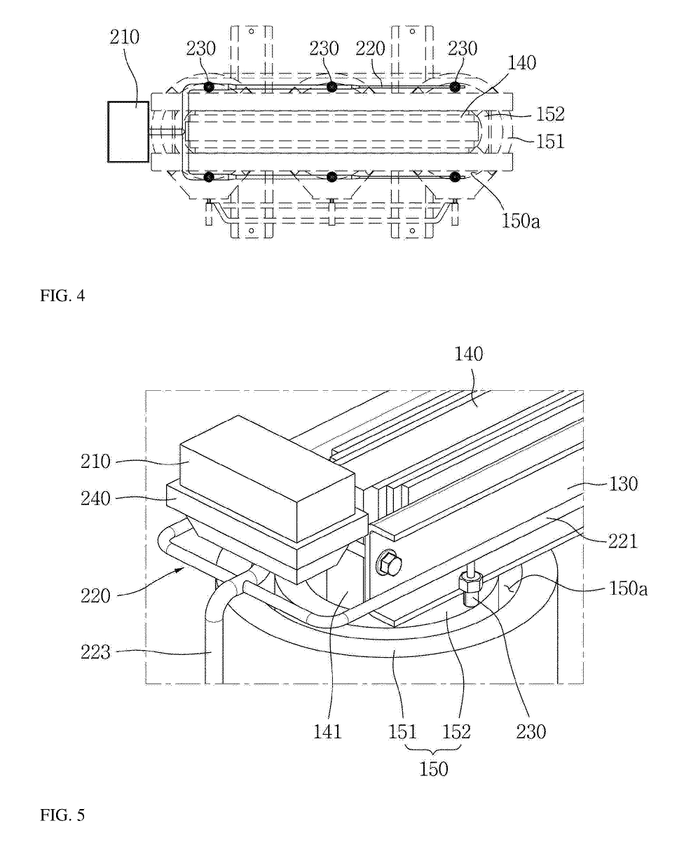

The technical features of the present invention will be described in detail, with reference to FIGS. 1 through 7.

In FIG. 1, a mold transformer with the solid aerosol fire extinguisher according to the present invention comprises a structure 100 and a fire extinguisher 200. The structure 100 comprises a base 110, a lower frame 120 positioned on the base 110, an upper frame 130 vertically spaced apart from the lower frame 120, a core 140 positioned between the frames, a coil section 150 positioned outside the core 140. The fire extinguisher 200 to suppress a fire is positioned at one side of the upper frame 130.

The base 110 to support the mold transformer is positioned at the bottom of the mold transformer. The base 110 may be a pair of rods with moving units, to move the transformer. The lower frame 120 is positioned on the base 110.

‘⊏’-shaped steel may be used for the lower frame 120, which is across the base 110. A plurality of the lower frames 120 may be used. A pair of frame members is connected to each other by connecting members as shown. Preferably, the connecting members may pass through the lower frame 120 to secure the core 140, which will be later described.

The upper frame 130 is spaced apart from the lower frame 120 upwardly. The upper frame 130 may be formed similarly with the constitution of the lower frame 120 described above. That is, the upper frame 130 is prepared with a pair of frame members and the connecting members and installed to secure the upper side of the core 140.

The lower frame 120 and the upper frame 130 secure the lower and upper sides of the core 140. Preferably, the lower frame 120 and the upper frame 130 may be connected by special securing rods (not shown).

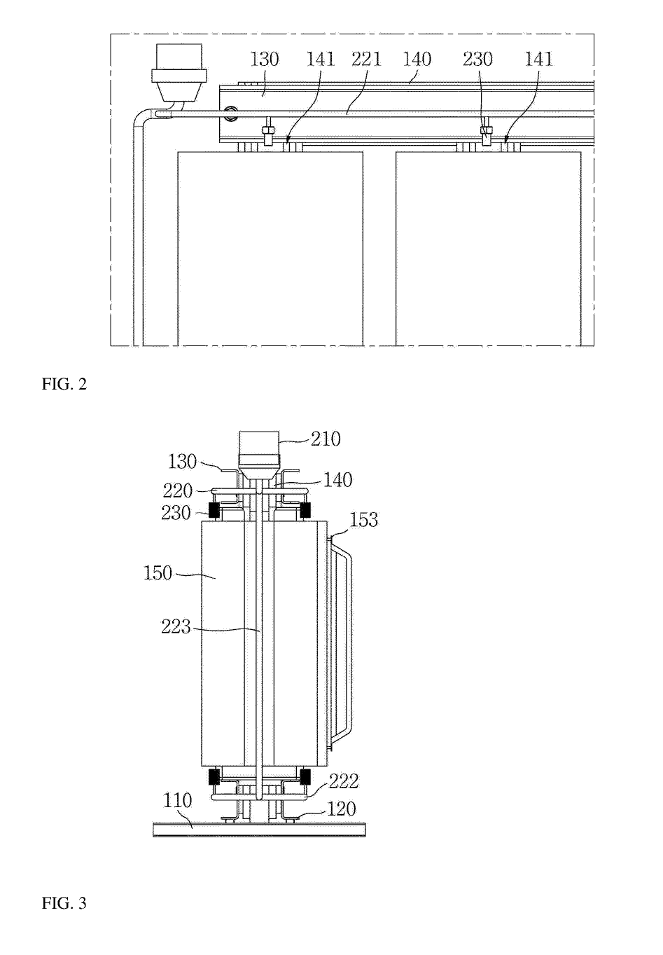

The core 140 is installed by horizontally stacking a number of steel sheets standing vertically. The core 140 is arranged in the length direction of the frames and a core unit 141 extends to pass through a secondary coil 152, which will be later described. Generally, it is preferable to form a plurality of the core units 141 in the core 140. In the embodiments of the present invention, the core units 141 are surrounded by three pairs of the coil sections 150 as shown in FIG. 1 and FIG. 2.

The coil section 150 is positioned outside the core 140. The coil section 150 includes a primary coil 151 and a secondary coil 152. That is, the primary coil 151 and the secondary coil 152 are positioned outside each of the coil units 141.

The coil section 150 includes the primary coil 151 positioned outside the core 140 and the secondary coil 152 positioned inside the primary coil 151 around the core unit 141 of the core 140.

The primary coil 151 and the secondary coil 152 vertically extend between the lower frame 120 and the upper frame 130. Each of the primary coil 151 and the secondary coil 152 has a cylindrical shape around the core unit 141 of the core 140.

The primary coil 151 has an inner space and the secondary coil 152 has an inner space. The secondary coil 152 is positioned within the inner space of the primary coil 151 and the core unit 141 of the core 140 is positioned in the inner space of the secondary coil 152. In other words, the secondary coil 152 is positioned outside the core unit 141 and the primary coil 151 is positioned outside the secondary coil 152.

A space 150a with a certain gap is formed between the inner surface of the primary coil 151 and the outer surface of the secondary coil 152.

Each of the primary coil 151 and the secondary coil 152 is made in the cylindrical shape by putting a wound coil into a mold and injecting an epoxy resin into the mold, to be insulated from the surrounding components. Electrodes 153 to be electrically connected to the outside are arranged to the primary coil 151 and the secondary coil 152, respectively.

The mold transformer includes the fire extinguisher 200.

The fire extinguisher 200 to spray a fire extinguishing agent to the coils, to suppress a fire, comprises: a precipitator 210, a distributing pipe 220, and a discharge nozzle 230. The fire extinguisher 200 is secured to the structure 100 by a support fixture 240 and the support fixture 240 is secured to the outside of the upper frame 130.

The precipitator 210 is a container to store the fire extinguishing agent to suppress a fire which breaks out in the mold transformer. The precipitator 210 is positioned at an end of the upper frame 130.

According to the present invention, the kind of the fire extinguishing agent stored in the precipitator 210 is a solid aerosol fire extinguishing agent. The precipitator 210 may use any container that can contain the fire extinguishing agent. In the embodiments of the present invention, the precipitator 210 is a funnel-shaped container.

Since the precipitator 210 stores the solid fire extinguishing agent, preferably it is positioned at an upper side of the transformer rather than a lower side, enabling an easy movement of the fire extinguishing agent in the direction of gravity. Thus, a connection section is formed under the precipitator 210 to be connected to the distributing pipe 220 and the connection section may be formed towards a downward direction.

One end of the distributing pipe 220 is connected to the connection section of the precipitator 210, to move the fire extinguishing agent stored in the precipitator 210 to the discharge nozzle 230 and the distributing pipe 220 includes an upper pipe 221 extending along the upper frame 130.

The upper pipe 221 extends from the distributing pipe 220, along the upper frame 130 and is divided into two, along the front and back of the upper frame 130. The upper pipe 221 is arranged above each of the core units 141 at both sides.

The distributing pipe 220 may further include a lower pipe 222 extending along the lower frame 120. Preferably, the distributing pipe 220 includes a connection pipe 223 to connect the lower pipe 222 to the upper pipe 221.

The lower pipe 222 is connected to one point of the upper pipe 221 through the connection pipe 223 and extends along the lower frame 120, such that the lower pipe 222 and the upper pipe 221 are symmetrical. Likewise the upper pipe 221, the lower pipe 222 is divided into two, to be positioned at the front and back of the lower frame 120.

The distributing pipe 220 is provided with the discharge nozzle 230 corresponding to the position of each core unit 141.

The discharge nozzles 230 to spray the fire extinguishing agent stored in the precipitator 210 are spaced apart from one another, such that each of the discharge nozzles 230 corresponds to each of the core units 141, along the distributing pipe 220. That is, the discharge nozzles 230 are installed at the upper pipe 221 and the lower pipe 222.

Since the upper pipe 221 of the distributing pipe 220 is divided into two, along the front and back of the upper frame 130, two discharge nozzles 230 are arranged above each core unit 141 at both sides. Also, since the lower pipe 222 of the distributing pipe 220 is divided into two, along the front and back of the lower frame 120, two discharge nozzles 230 are arranged under each core unit 141 at both sides.

This arrangement of the discharge nozzles 230 may relatively vary in capacity, size and number, etc. in proportion to the shape of the mold transformer.

For example, the discharge nozzles 230 may be arranged between the core units 141. When three core units 141 are present as shown, the discharge nozzles 230 may be not arranged to correspond to each core unit 141 but positioned between the core units 141. Accordingly, at least four discharge nozzles may be arranged above the core units 141 and at least four discharge nozzles may be arranged under the core units 141. Preferably, this arrangement may be used when the capacity of the mold transformer is small and the protection area according to the fire extinguishing capability of the discharge nozzles 230 is large.

According to the present invention, preferably, the discharge nozzles 230 are directly arranged at the location where the repetition rate of fire is highest in the mold transformer. That is, the discharge nozzle 230 needs to set the injection direction of the nozzle to enable a direct spray to the fire region.

So, in the discharge nozzle 230, a nozzle entrance is arranged downwardly towards the core unit 141.

Preferably, the discharge nozzle 230 is positioned so that the nozzle entrance is arranged towards the space 150a between the primary coil 151 and the secondary coil 152, to effectively spray the fire extinguishing agent towards the fire breaking out inside.

The fire extinguishing agent is sprayed to the space 150a through the discharge nozzles 230. The fire extinguishing agent can be sprayed to the outside of the primary coil 151 through the discharge nozzles 230, by controlling an angle of an arrangement or a shape of a bevel which will be later described.

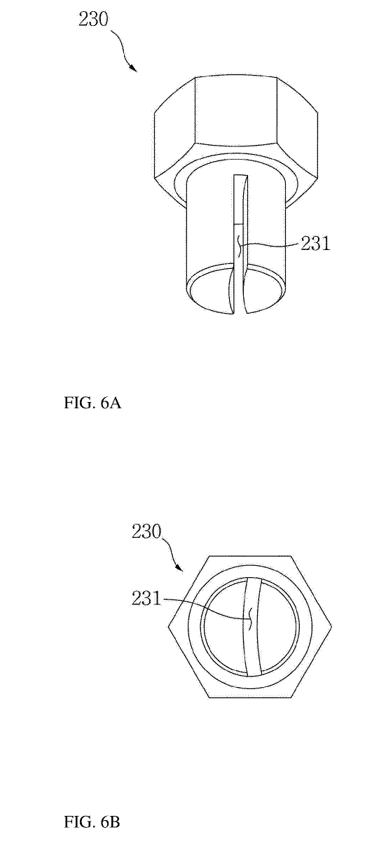

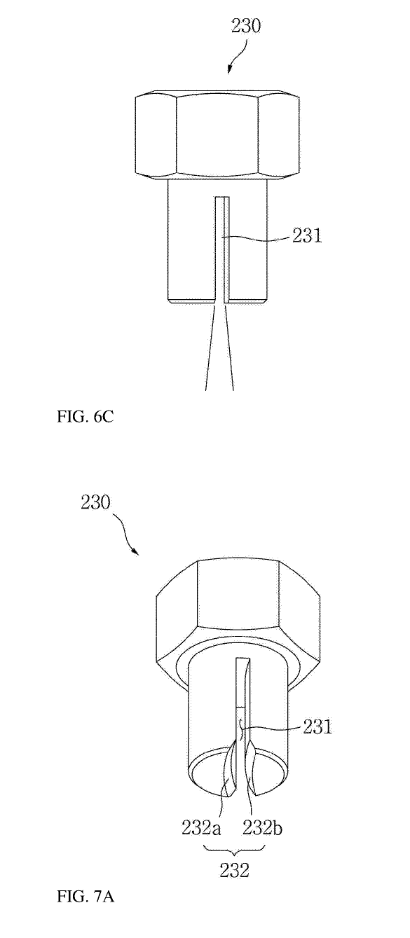

As shown in FIGS. 6A, 6B and 6C, the discharge nozzle 230 may include an arc groove 231 formed in a circular arc shape, to correspond to the space 150a between the primary coil 151 and the secondary coil 152.

The arc groove 231 is formed in an end of the discharge nozzle 230 and is processed to form a long channel in the circular arc shape, to guide a route through which the fire extinguishing agent is sprayed through the discharge nozzle 230.

When the discharge nozzle 230 sprays the fire extinguishing agent, since the form of spraying has a radial trajectory in the circular arc shape by the arc groove 231, the fire extinguishing agent is sprayed to the space 150a in a ring shape.

That is, the discharge nozzle 230 injects and sprays the fire extinguishing agent in the radial form corresponding to the space 150a through the arc groove 231. This is to spray the fire extinguishing agent to the area as large as possible within the space 150a between the primary coil 151 and the secondary coil 152 where the most fires break out in the core unit 141.

In other words, the form of spraying in the conventional nozzles has a cone shape with a circular section. However, since the form of spraying in the discharge nozzle 230 according to the present invention has a cone shape with a circular arc section having a thickness, the discharge nozzle 230 is able to spray the fire extinguishing agent properly to the space 150a in the ring shape and therefore effectively suppress the fire breaking out in the space 150a.

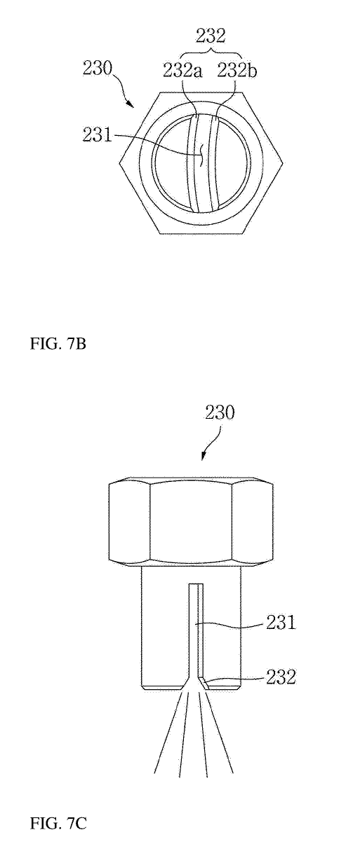

As shown in FIGS. 7A, 7B and 7C, the arc groove 231 may include a bevel 232 sloped at the end of the arc groove 231. That is, the arc groove 231 is terminated at the bevel 232 including a first bevel 232a and a second bevel 232b. The first bevel 232a is sloped towards the outside of the primary coil 151 and the second bevel 232b is sloped towards the inside of the secondary coil 152.

That is, in the discharge nozzle 230, the arc groove 231 is flared out at its end by the bevel 232.

Accordingly, when the fire extinguishing agent is sprayed through the arc groove 231 of the discharge nozzle 230, the fire extinguishing agent is sprayed over a greater area in a radial shape by the bevel 232 of the end of the arc groove 231.

In other words, the bevel 232 guides the fire extinguishing agent, which is released through the discharge nozzle 230, to be sprayed to the outside of the primary coil 151 in addition to the space 150a. The bevel 232 may guide the fire extinguishing agent to be sprayed to the inside of the secondary coil 152 which is the inside of the core unit 141, according to the shape of the bevel 232. The discharge nozzle 230 enables to spray the fire extinguishing agent to a larger area through the bevel 232.

The support fixture 240 of the fire extinguisher 200 extends from one side end of the upper frame 130. The support fixture 240 secured at the end of the upper frame 130 may be positioned to partially or entirely cover the outer surface of the precipitator 210, thereby more stably supporting the fire extinguisher 200.

The support fixture 240 may be made of a board in the shape to hold up the fire extinguisher 200. That is, the support fixture 240 is positioned at a bending portion 210a which is bent into the funnel shape of the precipitator 210. The support fixture 240 is installed to support the bending portion 210a to hold the precipitator 210.

According to another example, the support fixture 240 may include a support piece which is positioned at the bending portion 210a of the precipitator 210 and a push piece which is positioned at an upper position of the precipitator 210, thereby vertically supporting the precipitator 210 to be secured.

According to another example, the support fixture 240 may further include a grip piece (not shown) which is installed to cover the outer surface perimeter of the precipitator 210. The grip piece is fixed by a connecting member, such as a bolt, to wrap the outer surface of the precipitator 210 and one end of the grip piece is connected to the support fixture 240. This support fixture 240 is able to more firmly secure the precipitator 210 by the grip piece.

The fire extinguisher 200 described above is secured to the upper frame 120 by the support fixture 240 and is integrally formed with the structure 100 of the mold transformer.

Since the fire extinguisher 200 of the mold transformer according to the present invention includes a temperature sensor or the other devices, the fire extinguishing agent is automatically released through the discharge nozzles 230 to suppress a fire.

To this end, the fire extinguisher 200 may further include a sensor (not shown) and a panel (not shown) to recognize the sensor. The fire extinguishing agent can be sprayed through the panel. The sensors used in the present invention may include various kinds of a heat detector, a smoke detector, etc. The sensors may be positioned at the upper frame 130.

The operation of the fire extinguisher 200 according to the present invention will be described below:

The mold transformer of the present invention can be installed in the interior space of an electrical box (not shown). To this end, the mold transformer is installed in the interior space by opening a door of the electric box. In the present invention, since the fire extinguisher 200 is installed at the upper end at one side of the upper frame 130, any addition space is not needed in the interior space of the electric box.

A fire may break out in the mold transformer installed in the interior space of the electrical box. For example, flames or sparks can cause the epoxy resin forming the outer surfaces of the primary coil 151 and the secondary coil 152 to burn. Although the epoxy resin is a flame resistant material which is a non flammable material, a fire may break out by continuous flames or sparks from the wire, etc. connected to a terminal.

When a fire breaks out, the sensor detects the fire and when it reaches to a certain temperature, the fire extinguishing agent is automatically discharged. The fire extinguishing agent is mainly sprayed to the space 150a between the primary coil 151 and the secondary coil 152 and simultaneously to the outside of the primary coil 151. The fire extinguishing agent can be sprayed to the other places based on the positions of the discharge nozzles 230 if each nozzle entrance is arranged towards the places where fires may break out.

Specifically, the fire extinguishing agent which is released through the discharge nozzles 230 is directly sprayed to the space 150a between the primary coil 151 and the secondary coil 152, to perform the fire extinguishing process. In other words, since the fire extinguishing agent is directly sprayed to the place where the fire breaks out through the discharge nozzles 230, the fire is more rapidly suppressed.

A general round- or square-shaped nozzle sprays the fire extinguishing agent in a circular radial shape. However, in this invention, since the arc groove 231 is formed in the discharge nozzle 230, the fire extinguishing agent is sprayed in the arc shape of the arc groove 231 and as a result, it is sprayed in the shape corresponding to the shape of the space 150a between the primary coil 151 and the secondary coil 152.

That is, each of the discharge nozzles 230 according to the present invention effectively sprays the fire extinguishing agent to the space 150a between the primary coil 151 and the secondary coil 152, through the arc groove 231.

Further, since the discharge nozzle 230 has the bevel 232, the fire extinguishing agent is sprayed over a greater area through the bevel 232a towards the outer surface of the primary coil 151, without separately changing the direction of the nozzle entrance of the discharge nozzle 230.

Further, through bevel 232b, the fire extinguishing agent is sprayed to the inside of the secondary coil 152, that is, towards the core 140.

Consequentially, according to the present invention, the fire extinguishing agent is sprayed to the space 150a and the inner wall or outer wall of each coil. Even though the discharge nozzles 230 are respectively not installed at different angles towards the space 150a, the outer wall of the primary coil 151, or the inner wall of the secondary coil 152, since the fire extinguishing agent is sprayed to all of these places with one nozzle only, the total number of the discharge nozzles 230 is minimized.

In the mold transformer according to the present invention, the components of the fire extinguisher 200 are all positioned in the interior space of the electric box. This is to prevent the components from being damaged or worn out by the outside environments and therefore to prevent any damage to the fire extinguisher 200 and to keep the fire extinguisher 200 in a normal state for a long time.

While the present invention has been particularly shown and described with reference to examples thereof, it will be understood by those of ordinary skill in the art that various modifications and alternative arrangements in form and details may be made therein without departing from the spirit and scope of the present invention as defined by the following claims. The scope of the claims, therefore, should be accorded the broadest interpretation so as to encompass all such modifications and similar arrangements.

1. A mold transformer with a solid aerosol fire extinguisher comprising:
a base,
a lower frame positioned on the base,
an upper frame held to the lower frame,
a core vertically connecting the lower frame and the upper frame,
a secondary coil covered with an insulation material and positioned around the core,
a primary coil covered with insulation material and positioned around the secondary coil, and
a fire extinguisher positioned at one side of the upper frame, to spray a fire extinguishing agent which is a solid aerosol to a space between the primary and secondary coils and to the outer wall of the primary coil to suppress a fire, the fire extinguisher comprising:
a precipitator positioned at an end of the upper frame lengthwise, the outer perimeter of the precipitator downwardly tapered
a distributing pipe extending from the precipitator and including an upper pipe, a lower pipe and a connection pipe, and
a plurality of discharge nozzles installed at the upper pipe and the lower pipe.

2. The mold transformer with a solid aerosol fire extinguisher in claim 1, further comprising: a support fixture positioned at the one side of the upper frame, to support the fire extinguisher to be secured.

3. The mold transformer with a solid aerosol fire extinguisher in claim 1, wherein the discharge nozzle includes an end with a groove formed in a shape corresponding to the space between the primary and secondary coils, such that the solid aerosol is sprayed to the space through the groove.

4. The mold transformer with a solid aerosol fire extinguisher in claim 3, wherein the groove is formed in an circular arc-shaped long channel corresponding to the space in a ring shape.

5. The mold transformer with a solid aerosol fire extinguisher in claim 3, wherein the discharge nozzle is positioned to be close to the outer circumference surface of the secondary coil or the inner circumference surface of the primary coil.

6. The mold transformer with a solid aerosol fire extinguisher in claim 3, wherein the discharge nozzle is terminated at it send by a bevel and flared out by the bevel to spray the solid aerosol over a greater area.
